(19) United States
(12) Patent Application Publication
(10) Pub. No.: US 2007/0278373 A1
(43) Pub. Date: Dec. 6, 2007

(54) Sliding angle adjustment mechanism for holder

(76) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/447,102

(22) Filed: Jun. 6, 2006

(51) Int. Cl. F16M 13/00

(52) U.S. Cl. 248/419

(57) ABSTRACT

The present invention is to provide a sliding angle adjustment mechanism for a holding device, which comprises a support, a sliding pivot assembly and a base. The support has one end formed as a seat mounted with a clamping means for holding a portable electronic device thereon, and the other end pivotably secured to the sliding pivot assembly. The base has a top pivotably secured to the sliding pivot assembly and a bottom fixed to a flat surface. The sliding pivot assembly includes two grooves at both sides distal to the support such that the sliding pivot assembly is adapted to slide along the grooves toward the base for disposing the electronic device close to the base or away from the base for disposing the electronic device away from the base.

### FIELD OF THE INVENTION

The present invention relates to hands-free devices fixed to the interior of a motor vehicle, and more particularly to a holder fixed to the interior (e.g., dashboard) of an automobile and having an improved sliding angle adjustment mechanism such that a portable electronic device (e.g., mobile phone or a PDA (Personal Digital Assistant)) held thereon can be viewed clearly by sliding and adjusting to an optimum angle.

### BACKGROUND OF THE INVENTION

Technology has known a rapid, spectacular development in recent several decades. A variety of advanced electronic products are widely used by people. As a result, a lot of convenience is brought to our daily life and our living quality is improved significantly. Further, the fast development of such novel electronic products is closely associated with our daily life. Typical examples of the products are PDAs (Personal Digital Assistants) and mobile phones. These products are characterized in that they are portable, compact, and lightweight. Further, they are featured with memorandum, calendar, database, video game, phone book, dictionary, graphics, calculator, etc. As such, these portable electronic products are very popular among consumers. In response, more and more manufacturers of the art spend a lot of money and time in research and development of the portable electronic products. Hopefully, they can produce many types of portable electronic products with advantageous features such as being more powerful, compact, slim, and lightweight.

Applications of these portable electronic devices include, but not limited to, personal information management tool, video game machine, music player, and automobile navigation assistant. Typically, for ease of visual observation a well known holder is fixed to the interior (e.g., dashboard) of an automobile and a portable electronic device of the type described above is placed on or in the holder. In use, a drive may adjust the holder to an optimum angle. As such, the driver may easily, conveniently view messages shown on a display of the portable electronic device or use the portable electronic device while driving.

A variety of holders for holding a mobile phone in an interior of an automobile are commercially available. One such holder adhered to a fixed object (e.g., drink holder, glass holder, or the like) in an interior of an automobile is shown in FIG. 1. The holder comprises a rectangular base 1, a circular swivel mount 2 provided on the base 1 and having top gear teeth, a bracket 3 horizontally rotatably provided on a top of the swivel mount 2, a link 4 having one end hingedly interconnected two opposite flanges of the bracket 3, and a seat 5 having its bottom end pivotably provided at the other end of the link 4. A portable electronic device (not shown) may be mounted on the seat 5 and the base 1 is fixed to a flat surface (e.g., dashboard) of an automobile. A driver may turn both the swivel mount 2 and the link 4 to adjust height and inclined angle of the electronic device. Also, the driver may turn both the swivel mount 2 and the seat 5 to adjust a horizontal angle of the electronic device relative to the base 1. Hence, the driver may either mount the electronic device on the seat 5 at any angle or remove the electronic device from the seat 5.

However, the prior art holder suffered from a couple of disadvantages. For example, Its size is not fixed. Thus, length of the bracket 3 is also not fixed. In a case of the bracket 3 being relatively short, the driver may have difficulties of adjusting an angle of the bracket 3. Thus, the driver is unable to fully manipulate the bracket 3. As a result, the driver cannot clearly visually observe a display of a mobile phone held by the seat 5. In another case of the bracket 3 being bulky, the mobile phone held by the seat 5 is disposed excessively close to the driver. As such, other passenger(s) in the automobile may be interfered by the bracket 3 when moving. Also, the driver may have great difficulties of adjusting the holder to an optimum angle and disposition due to the relatively long bracket 3. As a result, it may cause danger while driving. Thus, it is desirable among the manufacturers in the art to provide a holder having an improved sliding angle adjustment mechanism such that a driver may easily adjust an angle and a disposition of the holder to optimum ones. Further, the driver may easily operate the holder in any angle so as to increase both user satisfaction and market competitiveness.

### SUMMARY OF THE INVENTION

After considerable research and experimentation, a sliding angle adjustment mechanism for holder according to the present invention has been devised so as to overcome the above drawback of the prior art.

It is an object of the present invention to provide a sliding angle adjustment mechanism for a holding device comprising a support, a sliding pivot assembly, and a base. The support has one end formed as a seat mounted with a clamping means for holding a portable electronic device thereon, and the other end pivotably secured to the sliding pivot assembly such that a pivoting of the support is adapted to pivot both the seat and the electronic device about one end of the sliding pivot assembly. The base has a top pivotably secured to the sliding pivot assembly. The sliding pivot assembly includes two grooves at both sides distal to the support such that the sliding pivot assembly is adapted to slide along the grooves toward the base for disposing the electronic device close to the base or away from the base for disposing the electronic device away from the base. A bottom of the base is fixed to a flat surface for supporting both the sliding pivot assembly and the support. By utilizing this holding device having a sliding angle adjustment mechanism, a user may easily adjust an angle and a disposition of each component so as to more conveniently operate the holding device in any desired angle.

In one aspect of the present invention the sliding pivot assembly comprises two grooves at both sides proximate the top of the base, the base comprises two opposite arms extended upright from its top and has its bottom fixed to the flat surface by creating a vacuum. A first pivot section is provided through the arms and the other end of the sliding pivot assembly such that the sliding pivot assembly is adapted to pivot between the arms. The first pivot section is provided to pass the arms and the other end of the sliding pivot assembly sequentially. The first pivot section comprises at least one projection facing either side of the other end of the sliding pivot assembly. The projections are fitted into the groove and are adapted to slide along the grooves.

In another aspect of the present invention the first pivot section further comprises a protrusion proximate the projections at the same side. The protrusion is adapted to slide along one side of the groove of the sliding pivot assembly when the projections slide along the groove. The sliding pivot assembly further comprises a plurality of equally spaced cavities along both sides of the groove. The protrusion is matingly engaged with any cavity. The protrusion is adapted to pass from one cavity to another when the sliding pivot assembly slides relative to the base. Also, the sliding pivot assembly is adapted to stepwise pivot about the top of the base. As an end, the electronic device is adapted to dispose either close to the base or away from same.

In a further aspect of the present invention the first pivot section further comprises a first limit member (e.g., male gear tooth member) and a second limit member (e.g., female gear tooth member). The first limit member has a first gear wheel on the other face and the second limit member has a first gear wheel on one face respectively. The first gear wheel of the first limit member is mesh with that of the second limit member. The first limit member is adapted to turn about the second limit member stepwise. One side of the first limit member is provided on one side of one arm facing the other arm. The projections are provided on a second limit member facing the sliding pivot assembly for causing both the first and second limit members to slide along the groove. In a case of the sliding pivot assembly pivoting between the arms, the sliding pivot assembly pivots stepwise between the arms. Also, a first positioning member is in mesh with a second positioning member. The first pivot section is adapted to support the sliding pivot assembly, the support, and the electronic device when the sliding pivot assembly is inclined.

The above and other objects, features and advantages of the present invention will become apparent from the following detailed description taken with the accompanying drawings.

### BRIEF DESCRIPTION OF THE DRAWINGS

FIG. 1 is an exploded view of a conventional holder for holding a portable electronic device in an interior of an automobile;

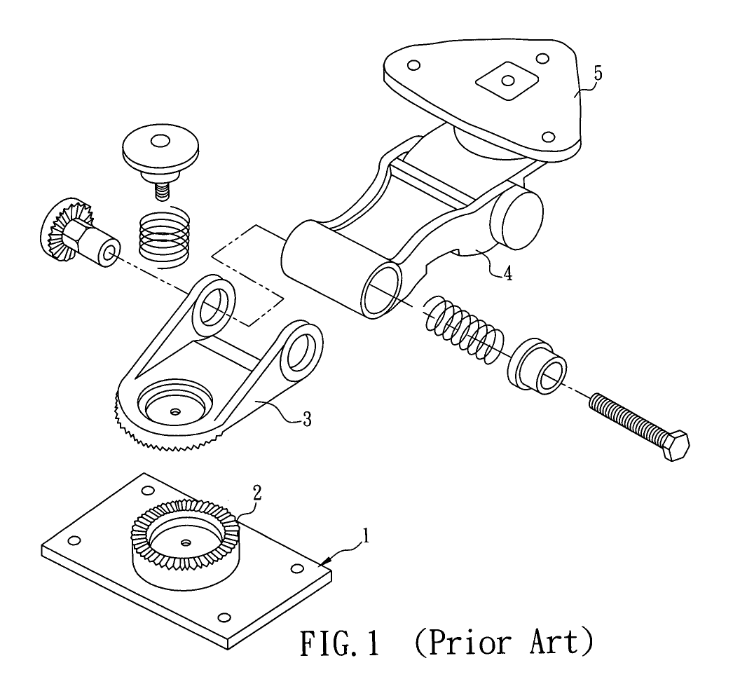

FIG. 2 is a perspective view of a preferred embodiment of holder for holding a portable electronic device in an interior of an automobile according to the invention;

FIG. 3 is an exploded view of the holder of FIG. 2;

FIG. 4 is a view similar to FIG. 2 where an operation state of the holder is shown; and

FIG. 5 is an exploded perspective view of the second gear wheel of FIG. 2.

### DETAILED DESCRIPTION OF THE PREFERRED EMBODIMENTS

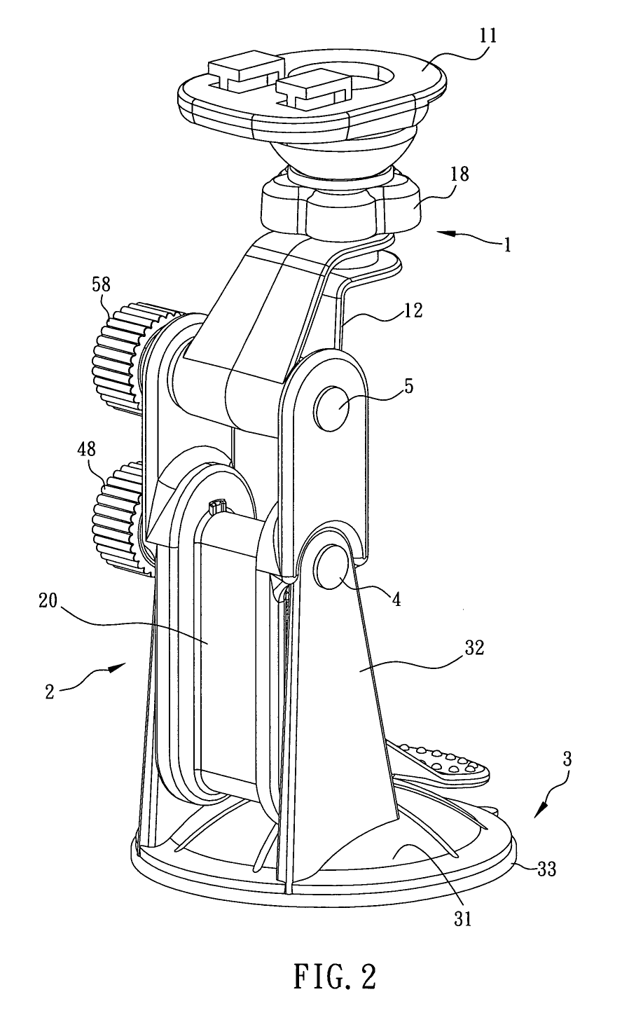

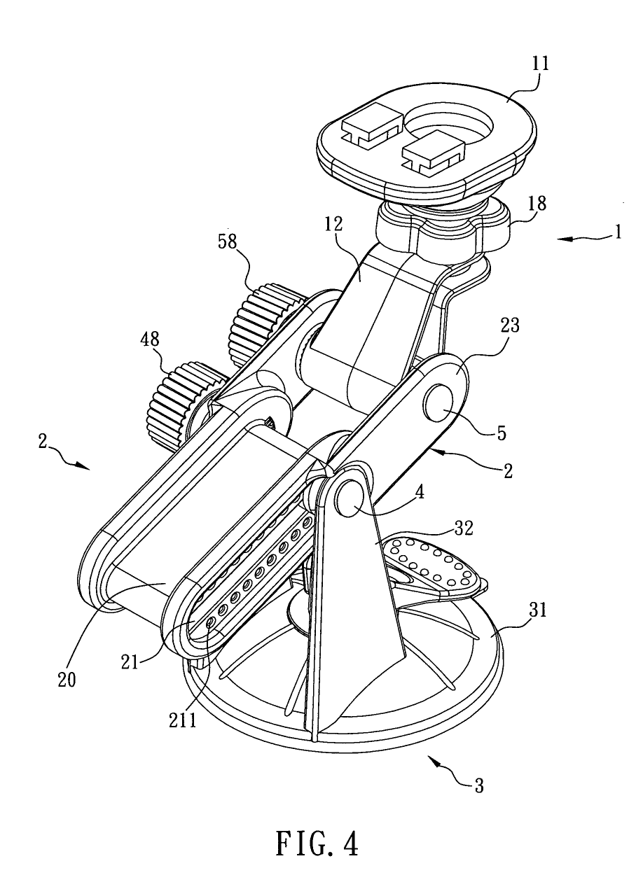

Referring to FIGS. 2, 3, and 4, a holder having a sliding angle adjustment mechanism in accordance with a preferred embodiment of the invention is shown. The holder comprises a support 1, a sliding pivot assembly 2, and a base 3. Each component is discussed in detailed below.

The support 1 comprises a seat 11 at one end for mounting an object thereon. The object is either a clamping device (not shown) or a portable electronic device (not shown). The other end of the support 1 is pivotably secured to the sliding pivot assembly 2. Thus, the support 1 having its seat 11 mounted with the electronic device is adapted to pivot about a top of the sliding pivot assembly 2. The other end (i.e., bottom) of the sliding pivot assembly 2 is pivotably secured to a top of the base 3. Thus, the sliding pivot assembly 2 is adapted to pivot about the base 3 for disposing the electronic device either close to the base 3 or away from same. A bottom of the base 3 is fixed to a flat surface (e.g., dashboard of an automobile) for supporting the support 1, the sliding pivot assembly 2, and the electronic device. By configuring as above, a driver may easily adjust an angle and disposition of each of the above components so as to more conveniently operate the holder.

Referring to FIGS. 2, 3, and 4 again, in the preferred embodiment of the invention the sliding pivot assembly 2 comprises an elongate body 20 having one end pivotably secured to the other end of the support 1. The elongate body 20 comprises two elongate grooves 21 at both sides distal to the support 1. The sliding pivot assembly 2 is pivotably secured to the top of the base 3. The sliding pivot assembly 2 is adapted to slide along the grooves 21 toward or away from the base 3. The base 3 comprises a disc-shaped plate member 31, two opposite arms 32 extended upright from a top of the plate member 31, and a suction cup 33 formed on a bottom of the plate member 31 and having a diameter slightly larger than or equal to that of a bottom of the plate member 31. The suction cup 33 is adapted to secure to a flat surface by creating a vacuum as well known in the art. The holder further comprises a first pivot section 4 formed through both sides of the sliding pivot assembly 2 and top ends of the arms 32. The first pivot section 4 is adapted to pivotably fasten one ends of the grooves 21 of the sliding pivot assembly 2 at the top ends of the arms 32. Thus, the sliding pivot assembly 2 is adapted to pivot between the arms 32. By configuring the sliding pivot assembly 2 and the first pivot section 4 as above, the sliding pivot assembly 2 is capable of pivoting between the arms 32.

The first pivot section 4 comprises a first limit member (e.g., male gear tooth member) 45 and at least one second limit member (e.g., female gear tooth member) 46. The first limit member 45 has a first gear wheel 451 on the other face and the second limit member 46 has a first gear wheel 451 on one face respectively in which the first gear wheel 451 of the first limit member 45 mates with (i.e., in gear engagement with) that of the second limit member 46. The first limit member 45 is adapted to turn about the second limit member 46 stepwise. The first limit member 45 is provided between the arm 32 and the groove 21 at one side. One side of the first limit member 45 is provided on one side of one arm 32 facing the other arm 32. Each of the second limit member 46 is provided between the first limit member 45 and the groove 21 at one side. As such, the elongate body 20 is pivotably fastened between the arms 32. In use, a driver may stepwise turn the first limit member 45 to dispose the sliding pivot assembly 2 in a suitable position in an angle adjustment operation.

The second limit member 46 comprises at least one projection 41 facing the sliding pivot assembly 2. The projections 41 are fitted into the groove 21 such that the sliding pivot assembly 2 is adapted to slide along the grooves 21. Therefore, in a case of the sliding pivot assembly 2 pivoting between the arms 32, the sliding pivot assembly 2 pivots stepwise between the arms 32. Also, the first limit member 45 is in mesh with the second limit member 46. Thus, the first pivot section 4 is adapted to support the sliding pivot assembly 2, the support 1, and the electronic device when the sliding pivot assembly 2 is inclined.

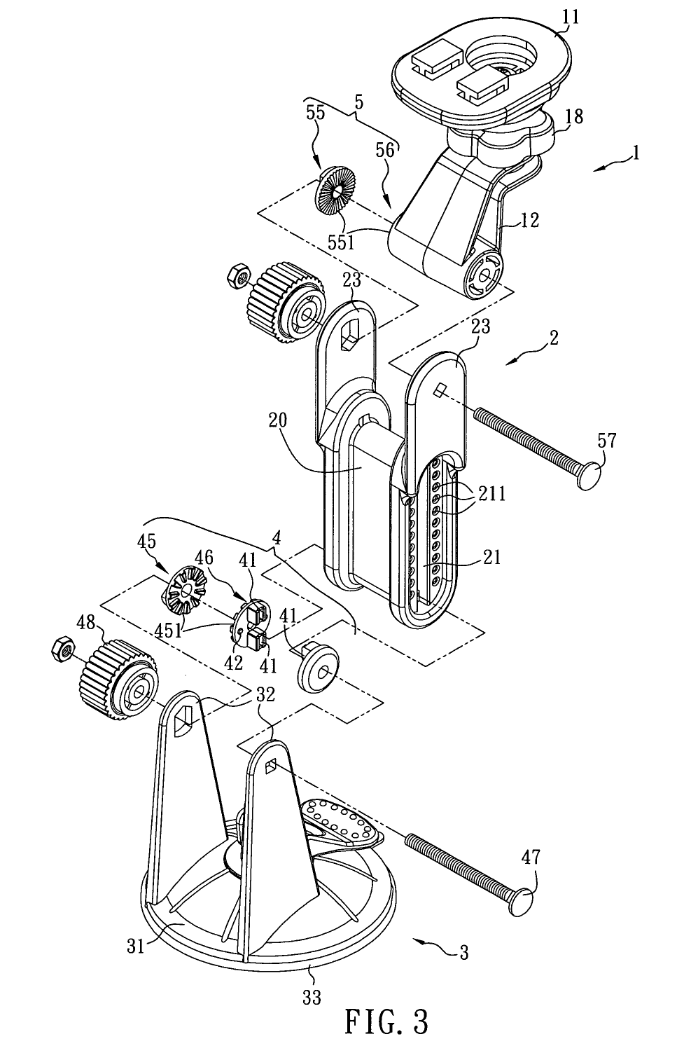

Referring to FIG. 3 again, in the preferred embodiment of the invention the second limit member 46 comprises a protrusion 42 proximate the projections 41 at the same side. The protrusion 42 is adapted to slide along one side of the groove 21 of the sliding pivot assembly 2 when the projections 41 slide along the groove 21. The sliding pivot assembly 2 further comprises a plurality of equally spaced cavities 211 along both sides of the groove 21. The protrusion 42 is matingly engaged with the cavity 211. Further, the protrusion 42 is adapted to pass from one cavity 211 to another one when the sliding pivot assembly 2 slides relative to the base 3. The sliding pivot assembly 2 is adapted to stepwise pivot about the top of the base 3 when the sliding pivot assembly 2 changes its position relative to the base 3. As an end, the sliding pivot assembly 2 is disposed in a suitable position relative to the base 3.

In addition, a first pin 47 is driven through the first pivot section 4 so as to pivotably fasten the sliding pivot assembly 2 and the base 3 together in one configuration. In detail, the first pin 47 sequentially passes a first adjustment knob 48, the first limit member 45, the second limit member 46, one arm 32, the grooves 21, the other arm 32, and a complimentary first adjustment knob 48 (not shown). Each of the first adjustment knobs 48 is provided externally of the arms 32 opposite the sliding pivot assembly 2. The first adjustment knobs 48 are fastened at both ends of the first pin 47. The fastened first adjustment knobs 48 are adapted to apply a force upon the arms 32 to urge them toward each other so as to pivotably fasten the sliding pivot assembly 2 therebetween.

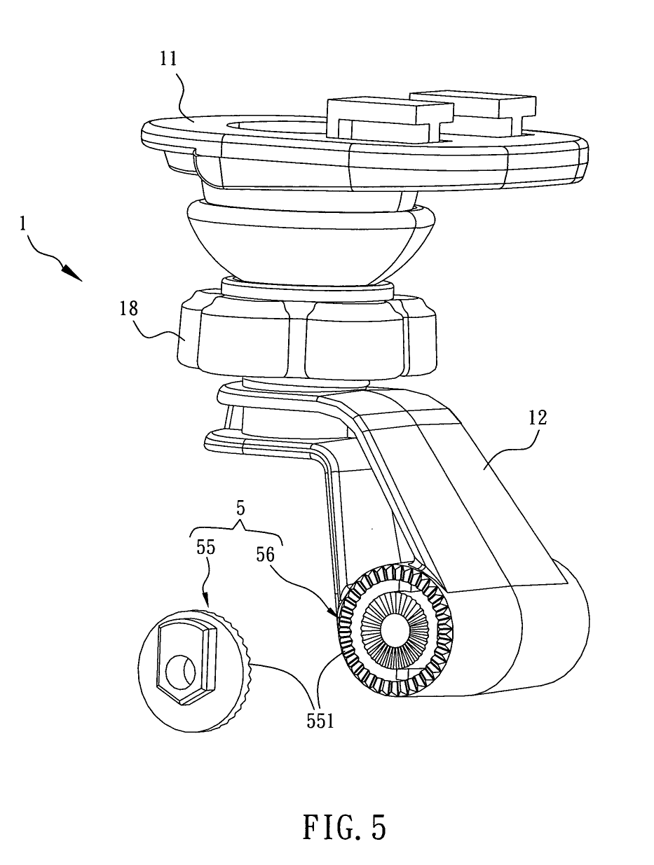

Referring to FIG. 5 in conjunction with FIG. 3, in the preferred embodiment of the invention the elongate body 20 further comprises two extension arms 23 projected from one end toward a bottom of the seat 11. A second pivot section 5 is driven through the extension arms 23 to pivotably fasten the support 1 between the extension arms 23 (i.e., the support 1 and the sliding pivot assembly 2 are pivotably secured together). As a result, the support 1 is capable of pivoting between the extension arms 23. The second pivot section 5 comprises at least one first positioning member (e.g., male gear tooth member) 55 and at least one second positioning member (e.g., female gear tooth member) 56. The first positioning member 55 has a second gear wheel 551 and the second positioning member 56 has a second gear wheel 551 respectively in which the second gear wheel 551 of the first positioning member 55 mates with (i.e., in gear engagement with) that of the second positioning member 56. The first positioning member 55 is provided between the support 1 and one extension arm 23 at one side. That is, the first positioning member 55 is provided onto one extension arm 23 facing the support 1. The second positioning member 56 is provided on one side of the support 1 facing the first positioning member 55 and is in mesh with the first positioning member 55. Thus, the first positioning member 55 is adapted to turn about the second positioning member 56 stepwise. The inclined support 1 is adapted to support the electronic device when the support 1 turns between the extension arms 23. At the same time, the support 1 may stepwise turn between the extension arms 23 so as to dispose in a suitable position in an angle adjustment operation.

In addition, a second pin 57 is driven through the second pivot section 5 so as to pivotably fasten the support 1 and the sliding pivot assembly 2 together in one configuration. In detail, the second pin 57 sequentially passes a second adjustment knob 58, one extension arm 23, the first positioning member 55, the second positioning member 56, the support 1, the other extension arm 23, and a complimentary second adjustment knob 58 (not shown). Each of the second adjustment knobs 58 is provided externally of the extension arms 23 opposite the sliding pivot assembly 2. The second adjustment knobs 58 are fastened at both ends of the second pin 57. The fastened second adjustment knobs 58 are adapted to apply a force upon the extension arms 23 to urge them toward each other so as to pivotably fasten the support 1 therebetween.

Referring to FIGS. 3 and 5 again, in the preferred embodiment of the invention the support 1 further comprises a link 12 having one end pivotably secured to the seat 11 such that the seat 11 with the electronic device held thereon is adapted to turn about the link 12. The support 1 further comprises a third adjustment knob 18 at a pivotal position between the seat 11 and the link 12. The third adjustment knob 18 is adapted to support the seat 11. A driver may turn the third adjustment knob 18 to fasten the seat 11. As such, the seat 11 is not able to turn (i.e., secured). The second pivot section 5 is driven through the extension arms 23 and the other end of the link 12 to pivotably secure the other end of the link 12 between the extension arms 23. As a result, the link 12 is adapted to support the seat 11 and the electronic device held thereon.

In view of the above, three pivotal components, namely the seat 11, the link 12, and the sliding pivot assembly 2 are provided by the invention. The sliding pivot assembly 2 is adapted to slide so as to dispose the electronic device close to the driver or away from same. By utilizing the invention, a driver may easily adjust an angle and a disposition of the holder. As such, an electronic device held by the holder is adapted to dispose in one of a plurality of different angles to enable a driver to clearly visually observe the electronic device in an optimum angle. As an end, the driver is able to conveniently operate the holder in any of desired angles.

While the invention herein disclosed has been described by means of specific embodiments, numerous modifications and variations could be made thereto by those skilled in the art without departing from the scope and spirit of the invention set forth in the claims.

What is claimed is:

1. A sliding angle adjustment mechanism for a holding device comprising:
a support having one end for mounting an object thereon;
a base having a bottom fixed to a flat surface; and
a sliding pivot assembly including an elongate body having one end pivotably secured to the other end of the support, the elongate body including two grooves at both sides distal to the support wherein the sliding pivot assembly is pivotably secured to a top of the base and is adapted to slide along the grooves toward or away from the base.

2. The sliding angle adjustment mechanism of claim 1, wherein the base comprises:
a plate member having a bottom secured to a flat surface by creating a vacuum;
two opposite arms extended upright from a top of the plate member; and
a first pivot section for pivotably fastening the grooves of the elongate body between the arms.

3. The sliding angle adjustment mechanism of claim 2, wherein the first pivot section comprises:
a first pin driven through the arms and the grooves;
at least one first limit member provided between one arm and one groove at one side wherein one side of the first limit member is provided on one side of one arm facing the other arm; and
at least one second limit member each provided between the first limit member and the groove at the same side with the first pin passed wherein the first limit member mates with and is in mesh with the second limit member; and the first limit member is adapted to turn about the second limit member stepwise for pivotably fastening the elongate body between the arms.

4. The sliding angle adjustment mechanism of claim 3, wherein each second limit member comprises at least one projection facing the sliding pivot assembly, the projection fitted into the groove such that the sliding pivot assembly is adapted to slide along the grooves.

5. The sliding angle adjustment mechanism of claim 4, wherein the second limit member comprises a protrusion proximate the projection, the protrusion adapted to slide along one side of the groove of the sliding pivot assembly when the projection slides along the groove.

6. The sliding angle adjustment mechanism of claim 5, wherein the sliding pivot assembly further comprises a plurality of equally spaced cavities along both sides of the groove, each of the cavities matingly engaged with the protrusion.

7. The sliding angle adjustment mechanism of claim 6, wherein the first pivot section further comprises a pair of first adjustment knobs each provided externally of the arms opposite the sliding pivot assembly, and wherein the first adjustment knobs are adapted to fasten for urging the arms toward each other so as to pivotably fasten the sliding pivot assembly therebetween.

8. The sliding angle adjustment mechanism of claim 7, wherein the first limit member comprises a first gear wheel on the other face and each second limit member comprises a first gear wheel on one face respectively, and wherein the first gear wheel of the first limit member is in mesh with that of the second limit member.

9. The sliding angle adjustment mechanism of claim 1, wherein the elongate body further comprises:
two extension arms projected from one end toward a bottom of the support and pivotably secured to the support; and
a second pivot section provided through the other end of the support and the extension arms to pivotably fasten the support between the extension arms.

10. The sliding angle adjustment mechanism of claim 9, wherein the second pivot section comprises:
a second pin driven through the extension arms and the other end of the support; and
a first positioning member provided between the support and one extension arm and positioned onto one extension arm facing the support.

11. The sliding angle adjustment mechanism of claim 10, wherein the support further comprises a second positioning member provided on one side of the support facing the first positioning member and being in mesh with the first positioning member such that the first positioning member is adapted to turn about the second positioning member stepwise and hold the support.

12. The sliding angle adjustment mechanism of claim 11, wherein the second pivot section further comprises a pair of second adjustment knobs each provided externally of the extension arms opposite the support, and wherein the second adjustment knobs are adapted to fasten for urging the extension arms toward each other so as to pivotably fasten the support therebetween.

13. The sliding angle adjustment mechanism of claim 12, wherein the first positioning member comprises a second gear wheel on the other face and the second positioning member comprises a second gear wheel on one face respectively, and wherein the second gear wheel of the second positioning member is in mesh with that of the first positioning member.

14. The sliding angle adjustment mechanism of claim 9, wherein the support comprises:
a seat pivotably provided at one end for holding and pivoting a portable electronic device mounted thereon; and
a link having one end pivotably secured to one end of the support and the other end pivotably secured between the extension arms so as to support the seat and the electronic device held thereon.

15. The sliding angle adjustment mechanism of claim 14, wherein the support further comprises a third adjustment knob provided at a pivotal position between the seat and the link, the third adjustment knob adapted to turn for fastening the seat so as to prevent the seat from turning.
